(19) United States
(12) Patent Application Publication
(10) Pub. No.: US 2011/0251901 A1
(43) Pub. Date: Oct. 13, 2011

(54) METHOD FOR AUCTIONING AND BILLING FOR SEARCH ADVERTISEMENT, SYSTEM, AND COMPUTER-READABLE RECORDING MEDIUM

(75) Inventors: Ki Oh Kwon, Seongnam-si (KR); Yuwon Kim, Seongnam-si (KR); Won Sook Noh, Seongnam-si (KR); Woongsup Shin, Seongnam-si (KR); Woosung Lee, Seongnam-si (KR); Min Seon Jeon, Seongnam-si (KR); Seojin Han, Seongnam-si (KR); Ha-Nyung Chung, Seongnam-si (KR)

(73) Assignee: NHN BUSINESS PLATFORM CORP, Seongnam-si (KR)

(21) Appl. No.: 13/063,154

(22) PCT Filed: Sep. 9, 2009
(86) PCT No.: PCT/KR2009/005108

§ 371 Date: May 26, 2011

(30) Foreign Application Priority Data
Sep. 9, 2008 (KR) 10-2008-0088748
Sep. 17, 2008 (KR) 10-2008-0091074
Sep. 18, 2008 (KR) 10-2008-0091809

(51) Int. Cl. G06Q 30/00

(52) U.S. Cl. 705/14.71

(57) ABSTRACT

A method, system, and computer-readable recording medium for holding an auction and imposing a charge in relation to a search advertisement are provided. The method includes receiving bid information related to the search advertisement from an advertiser calculating device, the bid information including a search keyword, a posted time of the search advertisement, and a bid price for the search advertisement, determining a posting position and/or a posting order of the search advertisement with respect to a predetermined time slot of the posted time of the search advertisement, based on the bid price corresponding to the time slot, and posting the search advertisement according to the determined posting position and/or the posting order for the predetermined time slot.

### TECHNICAL FIELD

The present invention relates to a method, system, and computer-readable recording medium for holding an auction and imposing a charge in relation to a search advertisement. More particularly, the present invention relates to a method, system, and computer-readable recording medium capable of holding an auction and imposing a charge in relation to a search advertisement in an improved manner, by determining an advertising fee based on a posted time of the search advertisement.

### BACKGROUND ART

With spread of the Internet of recent days, Internet users are able to obtain various information through Internet search portals. That is, users may connect to an Internet search site using an internet-accessible terminal such as a personal computer (PC), and search for various contents, for example, including news, knowledge, games, and communities.

As acquisition of information through the Internet is generalized, a search advertisement is being activated. The search advertisement offers an advertisement related to a search clue, such as a keyword, input by a user. The search advertisement further refers to an advertising method that posts advertisement information , for example, a webpage address of an advertiser, an one-line advertising message, and an image advertisement at a predetermined position on a search-result page in response to searches of a user using a specific keyword through a search engine. According to the search advertisement, advertisements may be offered to only users who performed searches by a relevant keyword, rather than to several unspecified persons. That is, the advertisements are targeted only to relatively prospective customers of goods or services offered by the advertiser. Therefore, the search advertisement is being popularized and widely applied.

Meanwhile, the advertiser who will pay cost for the search advertisement is highly interested in effectively exposing his or her advertisement to users within a budget advertising fee. According to such a need of the advertiser, various methods for charging an advertising fee have been introduced. For example, the charge method includes a cost per mille (CPM) method that calculates the advertising fee according to an exposed number of the advertisement, a cost per action (CPA) method that calculates the advertising fee according to a result of an action of the user, and a cost per click (CPC) that calculates the advertising fee according to a number of clicks performed by the user who selects and clicks the advertisement information such as a link in the webpage of the advertiser.

Generally, the search advertisement is sold through an auction between a plurality of advertisers and an advertisement provider. The CPM, CPA, and CPC methods may also be used for the auction of the search advertisement. For example, when a bid price is determined according to the CPC method, the advertiser may determine the bid price with respect to an ‘advertising fee charged per click’ occurring related to the search advertisement.

The foregoing conventional method for charge imposition and auction is reasonable considering that the advertising fee is charged according to occurrence of a charge basis, for example, exposure of the advertisement and clicking of the advertisement information. Conversely, the conventional method has a negative aspect in that the number of exposures of the search advertisement or the number of clicks of the advertisement information directly influences a charge for the advertisement. For example, the invalid exposure or the invalid click may often occur unnecessarily although they have no substantial advertising effect. However, the charge reflects even the invalid exposure or invalid click without any filtering so that the advertiser has to pay an excessive advertising fee. In fact, in the field of the search advertisement, such a problem is misused among competitor companies, for example by causing several times of meaningless exposure of a search advertisement or click of advertisement information of the search advertisement of competitor companies. Advertisers are suffering from increasing economic loss caused by such invalid exposure and the invalid click. When the economic loss caused by the invalid exposure and the invalid click continues, faith of the advertiser in the advertisement provider would be reduced. Consequently, the advertisement market may shrink.

### DISCLOSURE OF INVENTION

### Technical Goals

An aspect of the present invention is to solve all the aforementioned limitations.

Another aspect of the present invention is to suggest a new model of a search advertisement, capable of determining an advertising fee for the search advertisement based on a posted time of the search advertisement.

Another aspect of the present invention is to reduce unreasonable charging occurring due to invalid exposures and invalid clicks of an advertisement, by the new model of the search advertisement.

Another aspect of the present invention is to determine the advertising fee more reasonably by further employing a concept of a starting bid price in addition to the new search advertisement model.

Another aspect of the present invention is to prevent publication of an unsound search advertisement by restricting the advertiser from bidding with respect to an unsound search keyword or bidding for an advertisement of an unsound website.

Another aspect of the present invention is to prevent a successful bid from occurring even when the advertiser suggests a bid price beyond an advertising budget affordable by the advertiser.

Another aspect of the present invention is to prevent monopolization of search advertisements by a particular advertiser of high solvency.

Another aspect of the present invention is to determine the advertising fee based on a measured value of actual advertising traffic, an estimated value of estimated advertising traffic, and a bid price per unit time input by the advertiser.

Another aspect of the present invention is to reduce a gap between an estimated advertising effect and an actual advertising effect, caused by a difference between the measured value and the estimated value.

Another aspect of the present invention is to reduce the gap between the estimated advertising effect and the actual advertising effect by compensating the advertiser for the gap when the actual value is smaller than the estimated value.

### Technical Solutions

According to an aspect of the present invention, there is provided a method for holding an auction in relation to a search advertisement on a network, the method including receiving bid information related to the search advertisement from an advertiser calculating device, the bid information including a search keyword, a posted time of the search advertisement, and a bid price for the search advertisement; determining a posting position and/or a posting order of the search advertisement with respect to a predetermined time slot of the posted time of the search advertisement, based on the bid price corresponding to the time slot; and posting the search advertisement according to the determined posting position and/or the posting order for the predetermined time slot.

According to an aspect of the present invention, there is provided a method for imposing a charge in relation to a search advertisement on a network, the method including receiving bid information related to the search advertisement from an advertiser calculating device, the bid information including a search keyword, a posted time of the search advertisement, and a bid price for the search advertisement; determining a charge when posting of the search advertisement is completed, based on a posted time of the search advertisement and the bid price; and imposing the charge.

According to an aspect of the present invention, there is provided a system for holding an auction in relation to a search advertisement on a network, the system including an auction managing unit to receive bid information related to the search advertisement from an advertiser calculating device, the bid information including a search keyword, a posted time of the search advertisement, and a bid price for the search advertisement; and an advertisement executing unit to determine a posting position and/or a posting order of the search advertisement with respect to a predetermined time slot of the posted time of the search advertisement, based on the bid price corresponding to the time slot.

According to an aspect of the present invention, there is provided a system for imposing a charge for a search advertisement on a network, the system including an auction managing unit to receive bid information related to the search advertisement from an advertiser calculating device, the bid information including a search keyword, a posted time of the search advertisement, and a bid price for the search advertisement; and a charge managing unit to determine a charge based on a posted time of the search advertisement and the bid price when posting of the search advertisement is completed and to impose the charge.

According to an aspect of the present invention, there is provided a method for restricting bidding in relation to a search advertisement on a network, the method including receiving bid information related to the search advertisement from an advertiser calculating device, the bid information including a search keyword, a posted time of the search advertisement, and a bid price for the search advertisement; and determining whether to restrict bidding of the search advertisement based on the bid information, wherein the search advertisement is posted in a descending order of the bid price during the posted time of the search advertisements when the bidding is not restricted.

According to an aspect of the present invention, there is provided a system for restricting bidding in relation to a search advertisement on a network, the system including a communication unit to receive bid information related to the search advertisement from an advertiser calculating device, the bid information including a search keyword, a posted time of the search advertisement, and a bid price for the search advertisement; and a bidding restricting unit to determine whether to restrict the bidding in relation to the search advertisement based on the bid information, wherein the search advertisement is posted in a descending order of the bid price during the posted time of the search advertisements when the bidding is not restricted.

In addition, according to an aspect of the present invention, further provided are another method, system, and non-transitory computer readable recording medium storing a program to cause a computer to implement the method.

### ADVANTAGEOUS EFFECTS

Embodiments of the present invention suggest a new search advertisement model capable of determining an advertising fee with respect to a search advertisement based on a posted time of the search advertisement.

According to embodiments of the present invention, unreasonable charging occurring due to invalid exposures and invalid clicks of an advertisement may be reduced by the new model of the search advertisement.

According to embodiments of the present invention, the advertising fee may be more reasonably determined by further employing a concept of a starting bid price in addition to the new search advertisement model.

According to embodiments of the present invention, faith between the advertiser and an advertisement provider may be increased, consequently maintaining or expanding a search advertisement market while increasing profits of the advertisement provider.

According to embodiments of the present invention, publication of an unsound search advertisement may be prevented by restricting the advertiser from bidding with respect to an unsound search keyword or bidding for an advertisement of an unsound website.

According to embodiments of the present invention, a successful bid may be prevented when the advertiser suggests a bid price beyond an advertising budget affordable by is the advertiser.

According to embodiments of the present invention, monopolization of search advertisements by a particular advertiser of high solvency may be prevented.

According to embodiments of the present invention, the advertising fee may be determined based on a measured value of actual advertising traffic, an estimated value of estimated advertising traffic, and a bid price per unit time input by the advertiser.

According to embodiments of the present invention, a gap between an estimated advertising effect and an actual advertising effect, caused by a difference between the measured value and the estimated value, may be reduced.

According to embodiments of the present invention, when a measured value of actual advertising traffic is smaller than an estimated value of estimated advertising traffic, the advertiser is compensated for the difference. Thus, the gap between the estimated advertising effect and the actual advertising effect may be reduced.

According to embodiments of the present invention, the advertising fee is calculated per unit time using a bid price input according to a minimum bid price determined based on a use value per unit time of the advertisement region, rather than being calculated according to clicks of the advertisement. Therefore, problems caused by malicious clicks by one particular user or group may be fundamentally prevented.

### BRIEF DESCRIPTION OF DRAWINGS

FIG. 1 illustrates a view schematically showing a structure of an entire system for holding an auction and imposing a charge in relation to a search advertisement based on a posted time of a search advertisement, according to embodiments of the present invention;

FIG. 2 illustrates a view specifically showing an inner structure of a search advertising system according to an embodiment of the present invention;

FIG. 3 illustrates a view of an example interface screen showing that a bid price is determined according to specific time slots in relation to a specific search keyword, according to an embodiment of the present invention;

FIG. 4 illustrates a view of an example interface screen which is providing information on a bidding status in relation to a specific search keyword, according to an embodiment of the present invention;

FIG. 5 illustrates a view of an example interface screen which is providing a search advertisement and general search results in relation to a specific search keyword;

FIG. 6 illustrates a view schematically showing a structure of an entire system for restricting bidding by an advertiser when necessary, in a cost per time (CPT) advertisement model according to an embodiment of the present invention;

FIG. 7 illustrates a view specifically showing an inner structure of a search advertising system according to an embodiment of the present invention;

FIG. 8 illustrates a view specifically showing an inner structure of an interface providing unit in the search advertising system;

FIG. 9 illustrates a view specifically showing an inner structure of a bidding restricting unit in the search advertising system;

FIG. 10 illustrates a view showing an example interface provided by the interface providing unit;

FIG. 11 illustrates a view showing another example interface provided by the interface providing unit;

FIG. 12 illustrates a view showing still another example interface provided by the interface providing unit;

FIG. 13 illustrates a view for explaining an advertisement providing method according to an embodiment of the present invention;

FIG. 14 illustrates a flowchart showing an advertisement providing method according to an embodiment of the present invention;

FIG. 15 illustrates a graph showing information on an estimated value of advertising traffic and a bid price;

FIG. 16 illustrates a graph showing information on an estimated value of advertising traffic, a measured value of actual advertising traffic, a bid price, and an advertising fee;

FIG. 17 illustrates a graph showing information on a bid price and an advertising fee;

FIG. 18 illustrates a graph showing a cost per click (CPC) according to advertisement regions;

FIG. 19 illustrates a graph showing a number of clicks according to advertisement regions;

FIG. 20 illustrates a graph showing a use value according to advertisement regions;

FIG. 21 illustrates a block diagram explaining an inner structure of an advertisement providing system according to an embodiment of the present invention;

FIG. 22 illustrates a flowchart explaining an advertisement providing method according to another embodiment of the present invention;

FIG. 23 illustrates a block diagram explaining an inner structure of an advertisement providing system according to another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. These embodiments are provided so that this disclosure will be thorough and complete, and will fully convey the concept of the invention to those skilled in the art. The embodiments may be different but may be not exclusive. For example, specific features, structures, and forms disclosed herein may be realized in other embodiments without departing from the scope and range of the present invention. Positions and arrangements of individual element introduced in each embodiment may be altered without departing from the sprit and the scope of the present invention. Therefore, the embodiments should be considered in descriptive sense only and not for purposes of limitation. Therefore, the scope of the invention is defined not by the detailed description of the invention but by the appended claims, and all differences within the scope will be construed as being included in the present invention. The same reference numerals refer to the same or similar functions and structures throughout the drawings.

Hereinafter, exemplary embodiments of the present invention will be described in detail with reference to the accompanying drawings so that those generally skilled in the art can easily accomplish the present invention.

### Exemplary Embodiment

Herein, a term ‘search advertisement’ will collectively indicate an advertising method or an advertisement by the same, which enable certain advertisement information including, for example, a webpage address of an advertiser, an one-line advertising message, and an image advertisement to be posted at a predetermined position on a search-result page in response to searching by a user using a specific keyword (for example, a search keyword) through a search engine. In particular, the search advertisement described herein will be understood in a broad sense including even a keyword advertisement which enables posting of an advertisement related to the search keyword input by the user along with a search result provided by a search site according to the search keyword.

In addition, in the following description, a term ‘imposition’ refers to a series of processes imposing a cost on the advertiser for posting of the search advertisement. In particular, the imposition described herein will be understood in a broad sense including almost all kinds of imposition methods, for example, a cost per mille (CPM) method that calculates the advertising fee according to an exposed number of the advertisement, a cost per action (CPA) method that calculates the advertising fee according to a result of an action of the user, and a cost per click (CPC) that calculates the advertising fee according to a number of clicks performed by the user who selects and clicks the advertisement information such as a link in the webpage of the advertiser.

CPT Method

The CPT method newly suggested herein enables an advertiser to perform bidding in relation to a predetermined search keyword and a predetermined time period at a bid price set by the advertiser so as to post his or her search advertisement at a predetermined position on a search result page. The CPT method also enables posting of the search advertisement every time the user searches for the search keyword for the predetermined time period. An advertising fee incurred by the advertisement posting is determined, fundamentally, by the bid price and a posted time of the search advertisement.

According to the CPT method, a plurality of search advertisements, mostly of different advertisers, searched by one search keyword may be displayed on a search result page, being arranged according to bid prices of the plurality of search advertisements, for example, in a descending order of the bid prices. Here, other parameters besides the bid price, such as a level of the advertiser and an accumulated charge of the advertiser, may be considered in determining a position of the search advertisement.

In addition, the bidding may be handled as separate biddings according to respective time slots even though the bidding is related to one search advertisement. In this case, the bid price according to the time slots may also be varied by selection of the advertiser. The position of the arranged search advertisement may be varied according to the time slots.

However, the CPT method according to the embodiment is not limited to the foregoing method. That is, rights of all types of the CPT method, which are disclosed or implied below, may belong to the present applicant.

Structure of Entire System

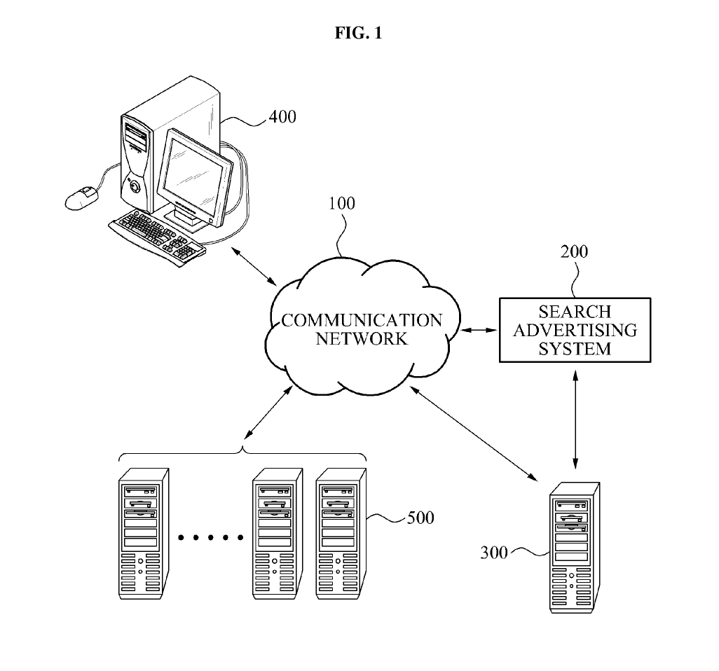

FIG. 1 schematically shows a structure of an entire system for holding an auction and imposing a charge in relation to a search advertisement based on the posted time of a search advertisement, according to embodiments of the present invention.

As shown in FIG. 1, the entire system may include a communication network 100, a search advertising system 200 to hold an auction and impose a charge with reference to the posted time of the search advertisement, an advertiser server or an advertiser terminal 300, a user terminal 400, and a plurality of web servers 500 to search for and supply contents corresponding to a search clue received from the user terminal 400 according to a user request.

First, the communication network 100 may be configured to be wired or wireless. Various communication networks such as a local area network (LAN), a metropolitan area network (MAN), a wide area network (WAN), and the like may be used as the communication network 100. As an example, the communication network 100 may be a world wide web (WWW) which is generally known.

According to the embodiment of the present invention, when an auction is held in relation to a search advertisement, the search advertising system 200 may enable the advertiser to bid for a specific search keyword with respect to a posted time of the search advertisement. For example, the search advertising system 200 may calculate a starting bid price with respect to the specific search keyword based on history data and provide the starting bid price to the advertiser, so that the advertiser determines a reasonable amount for an expected advertising effect of the search advertisement. Here, the history data may include a number of postings of the search advertisement during a predetermined past time, a number of clicks of advertisement information of the corresponding search advertisement, and a charge for the corresponding search advertisement.

In addition, the search advertising system 200 may provide the advertiser attending the bidding of a specific search advertisement with information on a current or recent bidding status such as estimated ranking, a highest bid price, and the like. Therefore, the advertiser may obtain an opportunity to change his or her set bid price by referring to the information on the bidding status.

Also, the search advertising system 200 may post the search advertisement of the advertiser who made a successful bid through the auction performed as corresponding to the search keyword input above by the user.

Furthermore, when the search advertisement is posted for a predetermined time, the search advertising system 200 may determine a charge based on the bid price and the posted time of the search advertisement.

The advertiser server 300 may be a server enabling the advertiser to perform communication by connecting to the search advertising system 200. However, the advertiser server 300 is not specifically limited but may include any type of digital device equipped with a memory and a microprocessor for a calculation function, such as a personal desktop or laptop computer, a workstation, a personal digital assistant (PDA), a web pad, and a mobile phone. Specifically, the advertiser server 300 may provide the search advertising system 200 with information on the search advertisement to be posted by the advertiser and the bid price, for example, the bid price per time slot and a total bid price. Also, the advertiser server 300 may receive information on the starting bid price and the bidding status from the search advertising system 200. The advertiser server 300 may be a homepage operation server operated by the advertiser to provide goods or service.

The user terminal 400 may be a digital device enabling the user to connect to and communicate with the web server 500 through the communication network 100. The user terminal 400 may include any digital device equipped with a memory and a microprocessor for a calculation function, such as a personal desktop or laptop computer, a workstation, a PDA, a web pad, and a mobile phone. The user terminal 400 may further include a program of a web browser (not shown) providing contents to the user according to the user request.

The web server 500 may communicate with the search advertising system 200 and the user terminal 400 through the communication network 100. The web server 500 may be equipped with a web contents search engine (not shown) to store the search keyword input by the user, search for contents corresponding to the search keyword, and enable the user to browse the search result. For example, the web server 500 may be an operation server of an internet search portal site. The contents provided as the search result may include various information , for example, news, knowledge, games, and communities. If necessary, the web content search engine may belong to a calculation device or a recoding medium, other than the web server 500. Although FIG. 1 shows the search advertising system 200 and the web server 500 as separate structures, the search advertisement 200 may be included in the web server 500 to provide a contents search service and a search advertisement service together according to a need of a person skilled in the art.

Structure of Search Advertising System

Hereinafter, an inner structure and respective elements of the search advertising system 200, which are essentially functional parts, will be described.

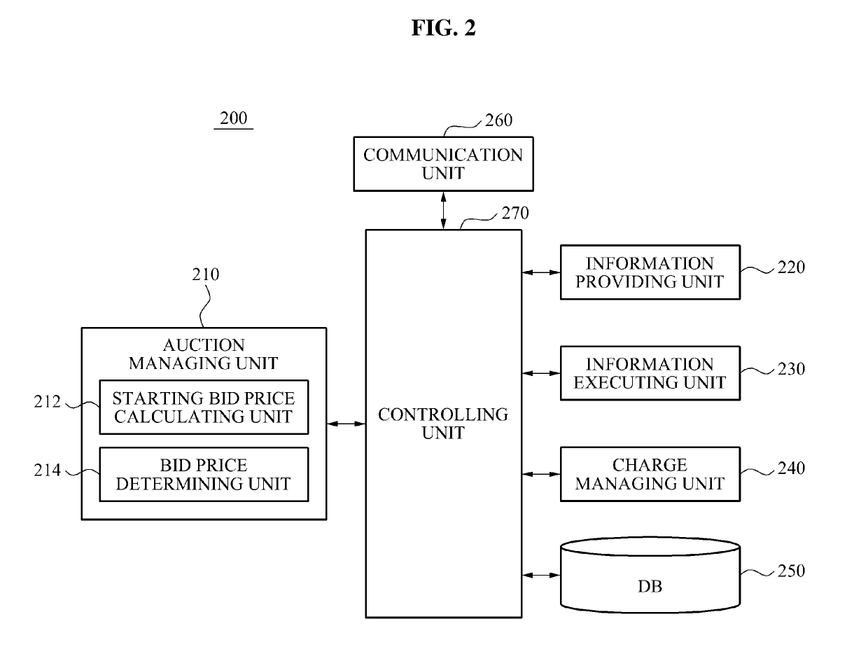

FIG. 2 illustrates a view specifically showing an inner structure of a search advertising system according to an embodiment of the present invention. Referring to FIG. 2, the search advertising system 200 includes an auction managing unit 210, an information providing unit 220, an advertisement executing unit 230, a charge managing unit 240, a database (DB) 250, a communication unit 260, and a controlling unit 270. The auction managing unit 210 may include a starting bid price calculating unit 212 and a bid price determining unit 214. According to an embodiment, at least some of the auction managing unit 210, the information providing unit 220, the advertisement executing unit 230, the charge managing unit 240, the DB 250, the communication unit 260, and the controlling unit 270 may be a program module that communicates with the advertiser server 300 and/or the user terminal 400. Those program modules may be included in the search advertising system 200 in the form of an operation system, an application program module, and other program modules. In terms of a physical structure, those program modules may be stored in various well-known memory devices. Also, those program modules may be stored in a remote memory device communicable with the search advertising system 200. Here, the program modules may include a routine, a sub routine, a program, an object, a component, and a data structure executing specific functions or abstract data forms, although not limited thereto.

The auction managing unit 210 may calculate the starting bid price with respect to the search keyword and determine the bid price so that the auction in relation to the search keyword selected by the advertiser is performed based on time. Additionally, when the bidding is completed, the auction managing unit 210 may make a successful bid of the search advertisement to n-number of advertisers who suggested relatively higher bid prices based on bid prices of respective advertisers. Hereinafter, the inner structure and respective elements of the auction managing unit 210 according to the example embodiment will be described with reference to FIG. 2.

The starting bid price calculating unit 212 may perform at least one of functions of providing the history data regarding the search keyword selected by the advertiser, and calculating and providing the starting bid price of the search advertisement based on the starting bid price.

The starting bid price refers to an initial bid price differentially calculated according to an advertising effect of the respective search keywords, thereby functioning as an indicator of the advertising effect of the search keyword. In the auction where the bid price of the search keyword is determined based on a posted time of the search advertisement, when the starting bid price reflecting the advertising effect or value is provided as the initial bid price, the advertiser may be able to set a reasonable bid price by referring to the starting bid price while an advertisement provider may be able to sell the search advertisement at a reasonable price. According to the embodiment, the starting bid price may be calculated based on the posted time of the search advertisement. The time slot of the posted time may be expressed, for example, by a year, a month, a date, an hour, and a minute. In order to prevent the bid for the search keyword from being accepted at a cheap price, the starting bid price may serve as a minimum limit of the bid price of the search advertisement.

The starting bid price may be determined referring to the history data, more particularly, data related to the search advertisement of which charge imposition is completed or a charge is settled with respect to the same search keyword. For example, the starting bid price may be determined as a charge for the search advertisement performed with the same search keyword during a previous time slot. As another example, the starting bid price may be determined as an average of charges for the search advertisements performed with the same search keyword during several time slots.

The bid price determining unit 214 may determine the bid price in accordance with selection of the advertiser. The bid price of the advertiser may be determined by reflecting an adjusting value added or subtracted by the advertiser with respect to the starting bid price suggested by the starting bid price calculating unit 212. The adjusting value may be determined by the advertiser and transmitted from the advertiser server 300 to the search advertising system 200. For example, when the advertiser intends to increase the bid price from the starting bid price, the adjusting value may have a positive value. When the advertiser intends to decrease the bid price, the adjusting value may have a negative value. However, the advertiser may simply refer to the starting bid price and directly input his or her desired bid price from the advertiser server 300 to the search advertising system 200.

A specific advertiser may suggest an excessively high bid price to cause economic loss to other advertisers rather than with genuine intention. To prevent this, the bid price determining unit 214 may limit a range of the bid price that can be set by the advertiser. For example, the bid price determining unit 214 may limit the bid price set by the advertiser to about 1000% of the starting bid price. In addition, for example, the bid price determining unit 214 may give the advertiser an opportunity to change the bid price already set, to increase flexibility of the auction.

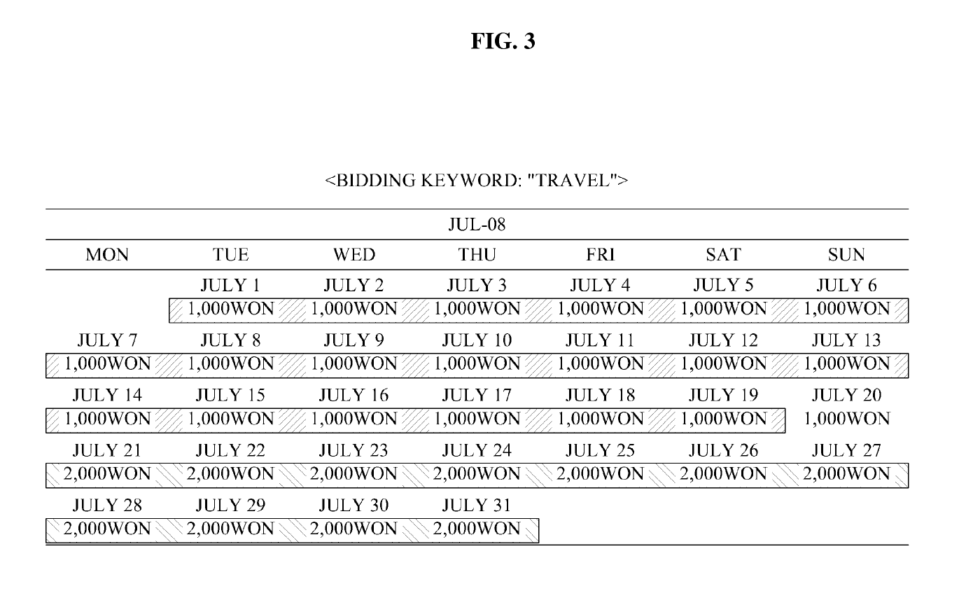

FIG. 3 illustrates an example interface screen showing that the bid price is determined according to specific time slots in relation to a specific search keyword, according to an embodiment of the present invention.

Referring to FIG. 3, the bid price is determined for posting of a search advertisement with respect to a search keyword “travel” for one day. The bid price is determined as “1000 won per day” in a time slot from July 1 to Jul. 19, 2008. The bid price is determined as “2000 won per day” in a time slot from July 21 to Jul. 31, 2008. However, the bid price does not have to be determined in one-day unit nor over a plurality of days.

The information providing unit 220 may provide the advertiser server 300 with information necessary for the advertiser to determine the bid price during an auction of the search advertisement. More particularly, the information providing unit 220 may provide statistical history information regarding the search advertisement using the specific search keyword, in order to solve uncertainty of the advertising effect and to enable the advertiser to estimate a value of the search advertisement to bid. Here, the statistical history information may include a number of exposures of the advertisement information or postings of the search advertisement during a predetermined past time, a click through rate (CTR) of exposure of the advertisement information with respect to posting of the search advertisement, ranking of the number of exposures, ranking of the number of postings.

In addition, the information providing unit 220 may provide bidding status information related to the specific search keyword to help the advertiser estimate bidding possibility and determine the bid price in the auction of the search advertisement. The bidding status information may include the bidding ranking predicted when the advertiser bids at a predetermined bid price, and the highest bid price.

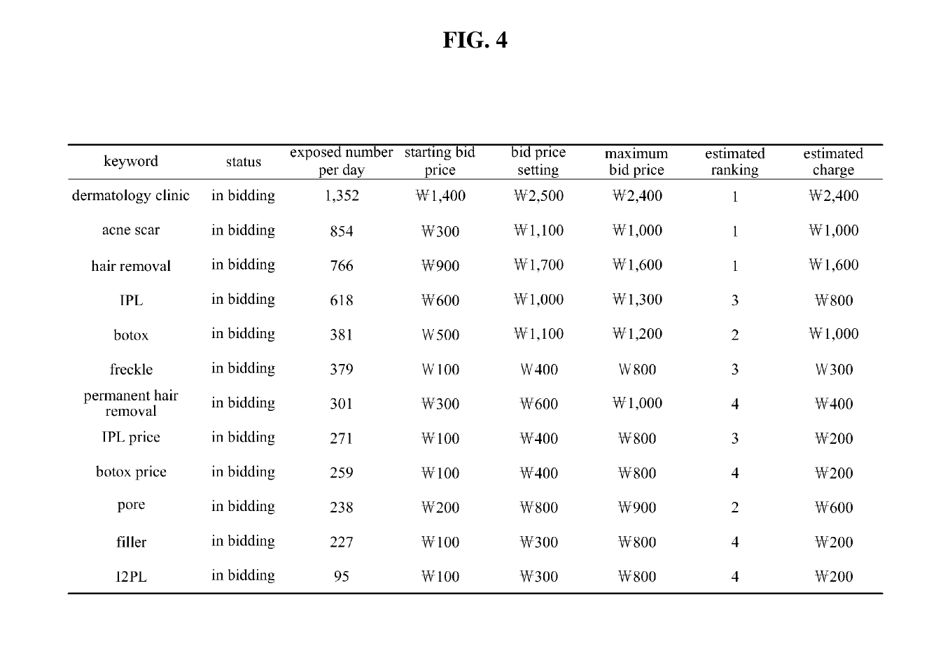

FIG. 4 illustrates an example interface screen showing information on the bidding status in relation to the specific search keyword, according to an embodiment of the present invention.

Referring to FIG. 4, information such as the bidding status, the starting bid price, the highest bid price, the estimated bidding ranking, and the estimated charge are provided according to respective search keywords.

Next, the advertisement executing unit 230 may post the search advertisements of the advertisers who made a successful bid in the auction, corresponding to the search keyword being input. In other words, when providing a search result corresponding to the input search keyword, the advertisement executing unit 230 may also post the advertises of the advertisers who made a successful bid in relation with the search keyword.

More specifically, the advertisement executing unit 230 determines a posting position and/or a posting order of the search advertisement in order of the bid price. For example, a search advertisement having a higher bid price may be posted in a relatively advantageous position. Also, the advertisement executing unit 230 may determine whether to post the search advertisement according to the corresponding posted time, to stop posting of a search advertisement of which the posted time is expired and start posting of a search advertisement of which the posted time is to be started. Thus, as the ranking of the bid price varies according to the time slots posting a specific search advertisement, the specific search advertisement may be posted in different positions in different time slots.

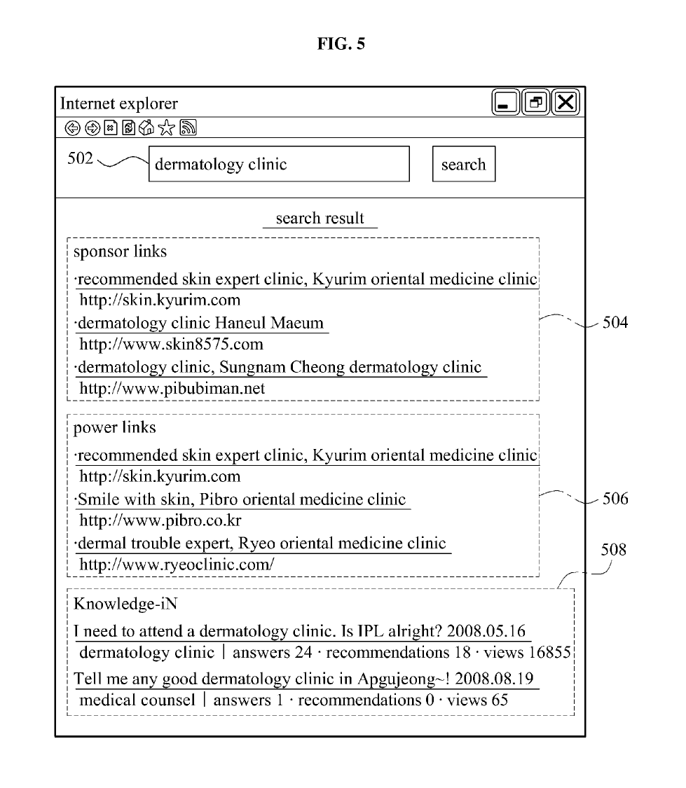

FIG. 5 illustrates an example interface screen showing the search advertisement and general search results in relation to the specific search keyword. For example, FIG. 5 shows the search result with respect to a search keyword 502 of “dermatologic clinic.” The search result may provide a plurality of search advertisements 504 and 506 of which bids were accepted, and a general search result 508 for the search keyword “dermatologic clinic.”

As shown in the drawing, the plurality of search advertisements 504 and 506 are posted in respectively different positions on the screen according to a predetermined order. Here, the posting position and/or the posting order of the search advertisements may be determined by the bid prices of the search advertisements. For example, search advertisements posted in a sponsor link 504 expected to have a relatively high advertising effect may have higher bid prices than search advertisements posted in a power link 506 expected to have a relatively low advertising effect. Among the search advertisements posted in the sponsor link 504, a search advertisement corresponding to the highest bid price may be posted in a first line of the sponsor link 504.

The charge managing unit 240 may impose a charge for the search advertisement of which posting is completed. As aforementioned, the charge managing unit 240 may calculate the charge based on a specific time slot during which the search advertisement is posted. For example, when a search advertisement accepted to be posted at “10 thousand won per day” regarding the search keyword “dermatologic clinic” is posted for 10 days, the charge managing unit 240 may calculate 100 thousand won as the charge.

The DB 250 may store various data related to the search advertisement. For example, the history data, various statistical information, the bidding statue information, and the like may be stored in the DB 250.

Although the DB 250 is included in the search advertising system 200 according to FIG. 2, the DB 250 may be separated from the search advertisement 200 according to a need of the skilled in the art. The DB 250 in the embodiments of the present invention has a broad meaning which includes a computer-readable recording medium and any database capable of data recording based of a file system. Even a simple log group may be included in the DB 250 as far as capable of searching and extracting data.

The communication unit 260 enables data transmission with respect to the search advertising system 200.

The controlling unit 270 may control data flow among the auction managing unit 210, the information providing unit 220, the advertisement executing unit 230, the charge managing unit 240, the DB 250, and the communication unit 260. Through the control of data flow by the controlling unit 270, those elements 210 to 260 may perform their own functions.

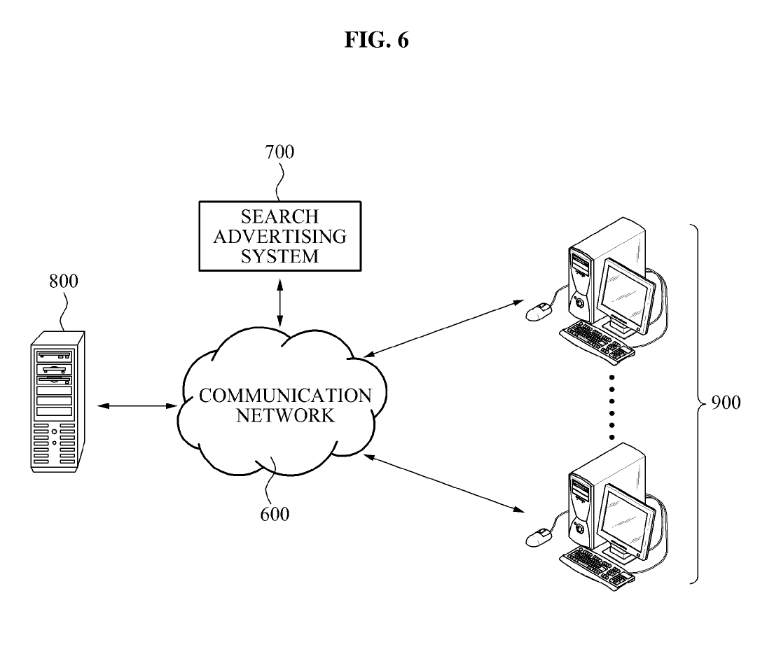

FIG. 6 schematically shows a structure of an entire system for restricting bidding by an advertiser when necessary, in a cost per time (CPT) advertisement model according to an embodiment of the present invention.

As shown in FIG. 6, the entire system may include a communication network 600, a search advertising system 700 to provide a search advertisement service according to the CPT method, an advertiser server (or an advertiser terminal) 800 to request an advertisement from the search advertising system 700 and to receive and transmit necessary information with respect to the search advertising system 700, and a plurality of user terminals 900 to receive the search advertisement by connecting to the search advertising system 700 and inputting a search keyword.

The communication network 600 may have a wired or wireless structure. Various communication networks such as a LAN, a MAN, a WAN, and the like may be used as the communication network 600. Exemplarily, the communication network 700 may be a generally known world wide web (WWW).

The search advertising system 700 may be requested for a CPT search advertisement by the advertiser server 800 through a bidding process, and provide the search advertisement to the user terminal 900 according to the search keyword input by the user. According to the embodiment, when receiving a request for bidding of the search advertisement from the advertiser server 800, the search advertising system 700 may also receive identification (ID) information regarding the advertiser (name, address, and contact information of the advertiser), ID information regarding a website of the advertiser (uniform resource locator (URL) of the website), an advertisement message, at least one search keyword corresponding to a search advertisement to be posted, information on the bid price, and the like.

The search keyword used for the search advertisement may be related to goods or service which is an object of the search advertisement. The search advertising system 700 may receive the request for bidding related to the search keyword from the advertiser server 800. According to an embodiment of the present invention, at least a part of search keywords may be restricted from bidding, according to a predetermined standard. For example, the search advertising system 700 may restrict bidding related to a search keyword which is offensive against public morals, a search keyword having an obscene meaning, and a search keyword related to goods socially unacceptable for distribution.

In addition, the search advertising system 700 may restrict bidding for a search advertisement of the web site of the advertiser according to a predetermined standard. For example, the website of the advertiser registered as an adult site or an illegal site may be restricted from bidding.

The search advertising system 700 may restrict bidding when the bid price suggested by the advertiser is unreasonably high. The advertiser registered in the search advertising system 700 may have an account to pay an advertising fee incurred by using the search advertisement service of the search advertising system 700. The advertiser may deposit a predetermined amount in the form of cyber money, for example, an electric coin, in the account. In this case, when the bid price according to the bidding request received from the advertiser server 800 is higher than a deposit balance in the account, the search advertising system 700 may restrict the bidding.

In addition, it is exemplary that the search advertisement service is provided at a reasonable advertising fee. Therefore, the search advertising system 700 may understand the search keyword and the bid price contained in the bidding request received from the advertiser server 800, and may restrict the bidding when the bid price according to the bidding request exceeds a predetermined range.

The advertiser may bid for a plurality of search keywords by varying the bid price. In this case, the search advertising system 700 may consider possibility of a successful bid of the corresponding advertiser with respect to the respective search keywords. Next, when a sum total of bid prices for the plurality of search keywords exceeds the deposit in the account of the advertiser, the search advertising system 700 may restrict the corresponding bidding. The possibility of the successful bid may be determined with reference to the history data regarding successful bids in the past. However, the possibility may be determined in other various methods.

The search advertising system 700 may determine whether to restrict the bidding for each unit time, based on characteristics of the CPT search advertisement model. For example, when a posting period or a charging period of the CPT search advertisement is one day, whether to restrict the bidding may be determined each day.

Also, when the bidding is restricted, the search advertising system 700 may transmit an alert message to the advertiser server 800. The advertiser of the advertiser server 800 may change the search keyword or adjust the bid price referring to the alert message to retry bidding.

The advertiser server 80 may be digital devices enabling the advertiser to connect to and communicate with the search advertising system 700. The digital devices may be an industrial server or a personal computer. For example, a desktop computer, a laptop computer, a workstation, a PDA, a web pad, and a mobile phone may belong to the personal computer. Other than, these examples, any type of digital device equipped with a memory and a microprocessor for a calculation function may be employed for the advertiser server 800.

More specifically, the advertiser server 800 may include an application program or a program module to transmit the bidding request to the search advertising system 700 and to receive the alert message notifying the bidding restriction or other information from the search advertising system 700. The application program or the program module may be transmitted from the search advertising system 700. The advertiser server 800 may be replaced by a homepage operation server operated by the advertiser to provide goods or service.

The user terminal 900 may be a digital device enabling the user to communicate with the search advertising system 700. Any digital device equipped with a memory and a microprocessor for a calculation function, such as a personal desktop or laptop computer, a workstation, a PDA, a web pad, and a mobile phone, may be used as the user terminal 900. In addition, the user terminal 900 may further include a program of a web browser (not shown) providing contents to the user according to the user request.

Hereinafter, the inner structure and respective elements of the search advertising system, which are essentially functional parts, will be described.

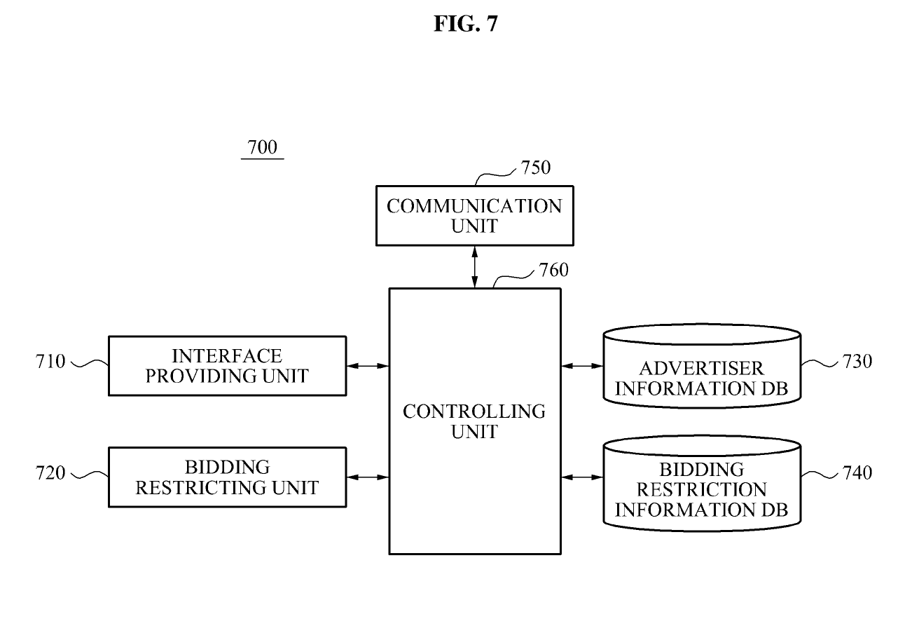

FIG. 7 illustrates a view specifically showing an inner structure of a search advertising system according to an embodiment of the present invention.

As shown in FIG. 7, the search advertising system 700 may include an interface providing unit 710, a bidding restricting unit 720, an advertiser information DB 730, a bidding restriction information DB 740, a communication unit 750, and a controlling unit 760. At least some of the interface providing unit 710, the bidding restricting unit 720, the advertiser information DB 730, the bidding restriction information DB 740, the communication unit 750, and the controlling unit 760 may be a program module that communicates with the advertiser server 800 and/or the user terminal 900. Those program modules may be included in the search advertising system 700 in the form of an operation system, an application program module, and other program modules. In terms of a physical structure, those program modules may be stored in various well-known memory devices. Also, those program modules may be stored in a remote memory device communicable with the search advertising system 700. Here, the program modules may include a routine, a sub routine, a program, an object, a component, and a data structure executing specific functions or abstract data forms, although not limited thereto.

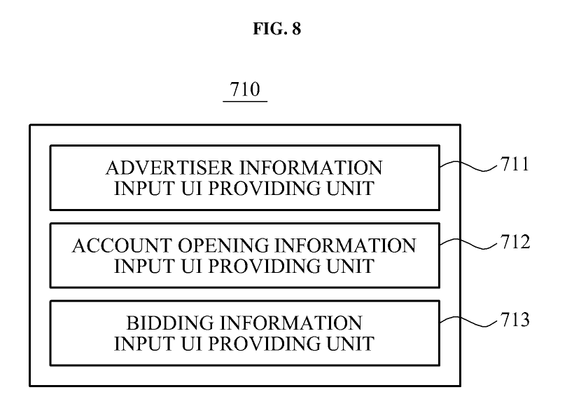

First, the interface providing unit 710 will be described with reference to FIG. 8. The interface providing unit 710 may provide the advertiser server 800 with an interface that enables the advertiser server 800 to transmit the bidding request or information necessary to open the advertiser account to the search advertising system 700.

Referring to FIG. 8, the interface providing unit 710 may include an advertiser information input user interface (UI) providing unit 711, an account opening information input UI providing unit 712, and a bid information input UI providing unit 713.

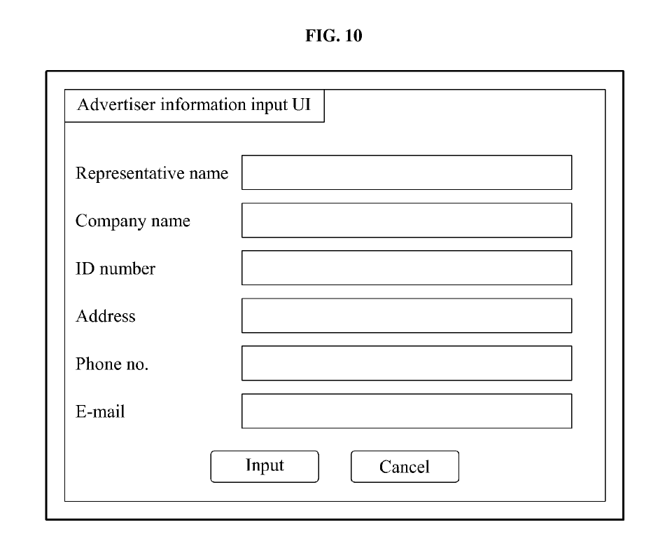

The advertiser information input UI providing unit 711 may provide an interface enabling the advertiser server 800 to transmit advertiser information to the search advertising system 700. FIG. 10 illustrates a view showing an example interface provided by the interface providing unit 710. Specifically, FIG. 10 shows an example of an interface for input of the advertiser information, the interface provided by the advertiser information input UI providing unit 711. When the advertiser of the advertiser server 800 inputs his or her name, a company name, an ID number, an address, a phone number, an e-mail address, and the like through the interface as shown in FIG. 10, those information is transmitted to the search advertising system 700. The search advertising system 700 may store the received information in the advertiser information DB 730.

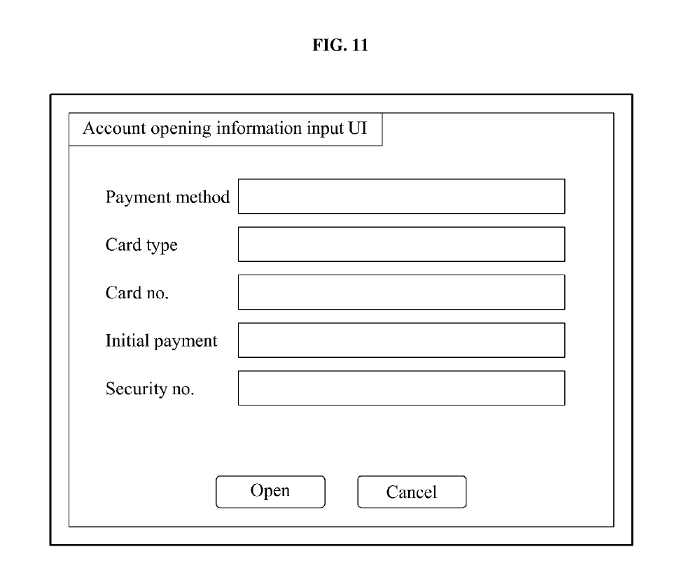

The account opening information input UI providing unit 712 may provide an interface enabling the advertiser to open an account to put in a deposit for use of the search advertisement service. FIG. 11 illustrates a view showing another example interface provided by the interface providing unit 710. FIG. 11 shows an example of the interface provided by the account opening information input UI providing unit 712. When the advertiser inputs a payment method, a paid amount, and the like in the advertiser server 800 through the interface shown in FIG. 11, the above information is transmitted to the search advertising system 700 and an account of the advertiser is opened. The account may be stored in the advertiser information DB 730 corresponding to the advertiser information input through the interface shown in FIG. 10. When the advertiser puts in a predetermined amount of deposit in the account, cyber money is accumulated in the account. Therefore, when the advertiser uses the search advertisement service, the cyber money corresponding to the advertising fee is deducted.

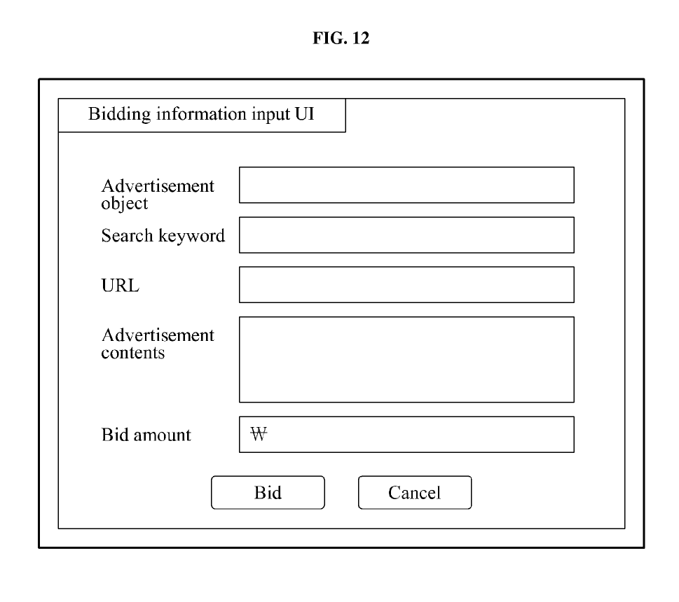

Next, the bid information input UI providing unit 713 provides an interface so that the bid information related to the search advertisement is received from the advertiser server 800. FIG. 12 illustrates a view showing still another example interface provided by the interface providing unit 710. Specifically, FIG. 12 shows an example of the interface provided by the bid information input UI providing unit 713. The advertiser may request for bidding related to the search advertisement, by inputting and transmitting information on a name of goods or service advertised by the advertisement, the search keyword, the URL of his or her website, the advertisement message, the bid price, and the like, to the search advertising system 700. Here, according to the CPT method, as the bid price of the advertiser is high, the possibility of the successful bid may increase and the search advertisement of the corresponding advertise may be posted in a more advantageous position.

The bidding restricting unit 720 may restrict bidding of the advertiser when necessary, based on the information input and transmitted by the advertiser through the interface provided by the interface providing unit 710.

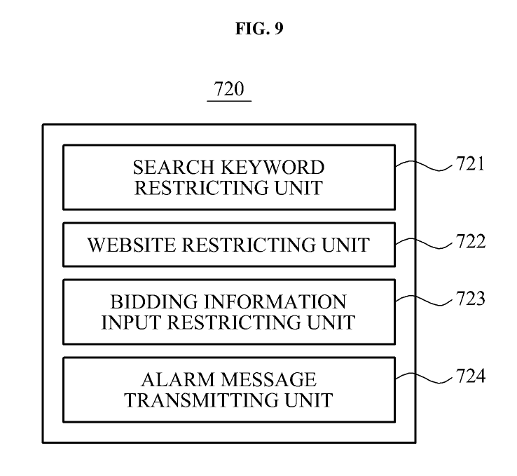

Hereinafter, the bidding restricting unit 720 will be described in detail by further referring to FIG. 9. As shown in FIG. 9, the bidding restricting unit 720 may include a search keyword restricting unit 721, a website restricting unit 722, a bid price restricting unit 723, and an alert message transmitting unit 724.

The search keyword restricting unit 721 may determine whether the search keyword is appropriate to request for bidding, based on the information transmitted from the advertiser server 800, and may restrict the corresponding bidding according to a determination result. For this, the search keyword restricting unit 721 may refer to the bidding restriction information DB 740 storing a list of inappropriate search keywords, that is, forbidden search keywords. In other words, the search keyword restricting unit 721 may restrict the bidding if the search keyword contained in the bidding request from the advertiser server 800 is included in the list of the forbidden search keywords stored in the bidding restriction information DB 740. The forbidden search keywords may include a search keyword offensive in view of public morals, a search keyword having an obscene meaning, and a search keyword related to goods socially unacceptable for distribution.

The website restricting unit 722 may determine whether the website of the advertiser according to the bidding request from the advertiser server 800 is appropriate for the bidding of the search advertisement, and may accordingly restrict the bidding. The bidding restriction information DB 740 may also be used in this process. The bidding restriction information DB 740 may store a list of adult sites and/or illegal sites.

In addition, the bid price restricting unit 723 may restrict bidding when the bid price is determined to be excessively high based on the information on the bid price received from the advertiser server 800.

The bid price restricting unit 723 may check a balance of deposit in the account of the advertiser based on the advertiser information DB 730, and restrict the corresponding bidding when a current bid price exceeds the balance of deposit. The current bid price may be a bid price related to one search keyword or a sum total of bid prices related to a plurality of search keywords. According to the embodiment, when the sum total of the bid prices related to the plurality of search keywords is greater than the balance of deposit, the bid price restricting unit 723 may restrict biddings from the most recent bidding related to individual search keyword until the sum total becomes less than the balance of deposit. At any case, the balance of deposit of the advertiser may be an amount remaining after deducting all advertising fee incurred by use of other search advertisement service, for example, the advertising fee incurred by purchase of a CPC search advertisement and the like, or deducting all outstanding advertising fees to be paid, for example, the advertising fee outstanding to be paid until posting of the search advertisement is actually completed by purchase of the CPT search advertisement according to the embodiment is of the present invention.

According to another embodiment of the present invention, the bid price restricting unit 723 may restrict bidding when a maximum allowable bid price related to a specific search keyword is set and the bid price requested by the advertiser is higher than the maximum allowable bid price. Information on the maximum allowable bid price may be stored in the bid information restriction information DB 740. For example, the maximum allowable bid price may be set to several times, such as five times, as much as a maximum advertising fee per unit time of the search advertisement performed in the past with the corresponding search keyword. Such restriction may be performed for each unit time or performed with respect to bidding of a search advertisement monopolizing for a predetermined period over several unit times.

When at least one of the search keyword restricting unit 721, the website restricting unit 722, and the bid price restricting unit 723 determines to restrict bidding of a certain advertiser, the alert message transmitting unit 724 may transmit an alert message to the advertiser server 800. The alert message may simply notify restriction of the bidding or may contain a reason of the restriction. The advertiser who received the alert message may adjust the search keyword, the website ID information, or the bid price input for request for the bidding, to retry the bidding request.

When the bidding is restricted due to lack of the balance in the account, the alert message transmitting unit 724 may transmit the alert message and then guide to recharge the deposit. For the deposit recharge, a generally-known cyber money accumulation scheme may be further applied.

The communication unit 750 may provide the interface from the search advertising system 700 to the advertiser server 800 and receive the bidding request from the advertiser server 800. As a whole, the communication unit 750 enables data transmission and reception with respect to the search advertising system 700. In addition, the communication unit 750 may receive a search request from the user terminal 900 and transmit a search advertisement along with a search result to the user terminal 900.

The controlling unit 760 may control data flow among the interface providing unit 710, the bidding restricting unit 720, the advertiser information DB 730, the bidding restriction information DB 740, and the communication unit 750. That is, the controlling unit 760 may control data flow from the outside or among the respective elements of the search advertising system 700, so that the interface providing unit 710, the bidding restricting unit 720, the advertiser information DB 730, the bidding restriction information DB 740, and the communication unit 750 may perform their own functions.

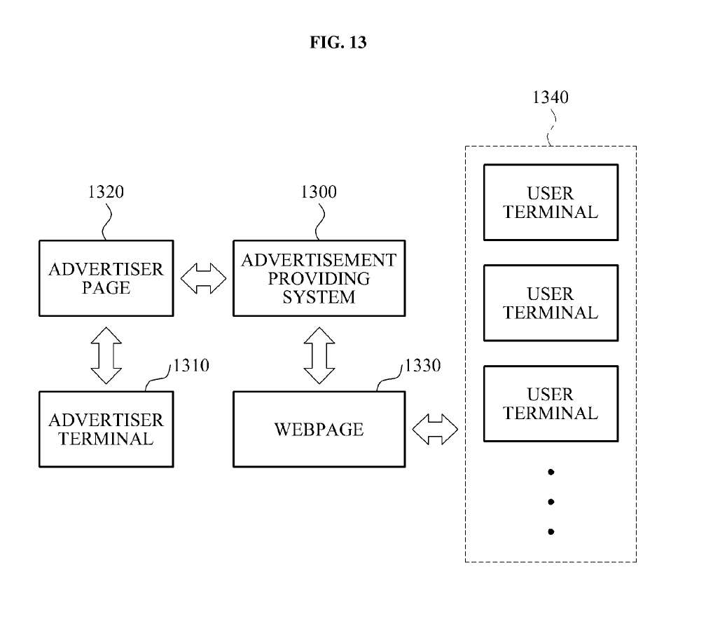

FIG. 13 illustrates a view for explaining an advertisement providing method according to an embodiment of the present invention. An advertisement providing system 1300 may provide an advertiser page 1320 to an advertiser terminal 1310 through a wired or wireless network, or provide various web pages 1330 to a plurality of user terminals illustrated in a dotted-line box 1340 in the drawing. The advertiser page 1320 may be one of the various web pages 1330. The advertiser terminal 1310 may be one of the plurality of user terminals.

Here, the advertisement providing system 1300 sells a plurality of advertisement regions to the advertiser through the advertiser page 1320, so that the advertisement of the advertiser is exposed through the advertisement regions. That is, one advertisement region may belong to at least one page of the various web pages 1330. When the at least one page is exposed through the user terminal, the advertisement of the advertiser may be exposed through the advertisement region which is exposed along with the page. In other words, the plurality of advertisement regions may be sold to the advertiser through an auction using the bid price. The advertisement of the advertiser may be exposed through the advertisement region for a time period selected by the advertiser.

The bid price may be determined and input by the advertiser based on estimated advertising traffic. The advertisement providing system 1300 may compensate the advertiser for a difference between an estimated advertising effect and an actual advertising effect that may be caused due to a difference between actual advertising traffic and the estimated advertising traffic. Here, when the actual advertising traffic is higher than the estimated advertising traffic, an additional charge may be incurred for an excess advertising traffic. However, the additional charge may not be imposed since the excess advertising traffic may influence a next bid price by reflecting the actual advertising traffic to the estimated advertising traffic at the time of next bidding.

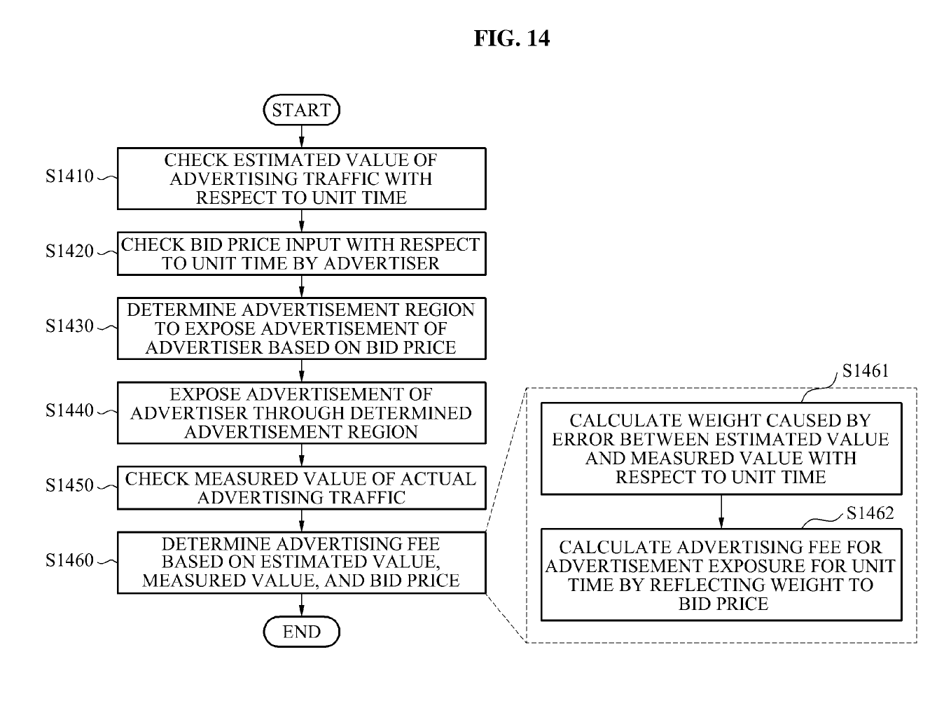

FIG. 14 illustrates a flowchart showing an advertisement providing method according to an embodiment of the present invention. The advertisement providing method may be performed by the advertisement providing system according to the embodiment of the present invention. FIG. 14 will explain the advertisement providing method by illustrating respective processes performed by the advertisement providing system.

In operation S1410, the advertisement providing system may check an estimated value of the advertising traffic of a unit time. For example, when one day is divided into 144 unit times of a 10-minute interval, the estimated value of the advertising traffic may be determined with respect to at least one of the 144 unit times. Therefore, the advertisement providing system may check the estimated value of the advertising traffic with respect to the unit time. Here, the advertising traffic may be expressed using at least one of any information capable of quantifying quantity of the advertisement, such as a number of exposures of the advertisement for a predetermined time or a page view. When the number of exposures is used to quantify the advertising traffic, an estimated number of exposures during the unit time may be calculated as the estimated value of the advertising traffic. The advertisement providing system may check the estimated value by referring to the estimated number of exposures.

In operation S1420, the advertisement providing system checks the bid price input with respect to the unit time by the advertiser. For example, the advertiser may input the bid price with respect to the unit time so as to expose the advertisement through the advertiser page 1320 explained with FIG. 13. The advertisement providing system may check the bid price being input. Here, since the estimated value of the advertising traffic is provided to the advertiser, the advertiser may determine the bid price to be input by referring to the estimated value. In addition, the bid price may be equal to or greater than a minimum bid price determined based on a use value per unit time of the advertisement region.

In operation S1430, the advertisement providing system may determine the advertisement region to expose the advertisement of the advertiser, based on the bid price. For example, the advertisement providing system may determine the advertisement region such that the advertisement region is sold to an advertiser suggesting a highest bid price among the input bid prices. The use value may be calculated using advertisement history information related to the advertisement region. The advertisement history information may include at least one of all types of measurable information related to the advertisement region, such as a number of clicks, a CPC, a number of hits, a number of exposures, and a number of purchases. That is, the use value may be an indicator representing use information of the corresponding advertisement region at a corresponding time. For example, the advertiser may purchase the advertisement region such that his or her advertisement is exposed through the advertisement region during a desired unit time among the 144 unit times, for example, during three unit times from 12:30 to 13:00 and four unit times from 15:00 to 15:40. Thus, since purchase of the advertisement region is performed based on the use value according to the time, the advertiser may efficiently obtain the advertising effect at a reasonable price. A method of calculating the use value will be described in further detail later.

In operation S1440, the advertisement providing system exposes the advertisement of the advertiser through the determined advertisement region. For example, the advertisement may be exposed to users through a corresponding advertisement region on the user terminals, the advertisement region among the advertisement regions exposed through at least one of the various web pages 1330 of FIG. 13.

In operation S1450, the advertisement providing system checks a measured value of the actual advertising traffic with respect to the unit time. For example, when the number of exposures of the advertisement is used a method of quantifying the advertising traffic, the measured value may be calculated as the number of exposures of the advertisement during the unit time. In this case, the advertisement providing system may refer to the number of is exposures to check the measured value.

In operation 1460, the advertisement providing system determines the advertising fee based on the estimated value, the measured estimated, and the bid price. For example, the advertisement providing system may determine the advertising fee such that a gap between the estimated advertising effect and the actual advertising effect is adjusted, the gap caused by the difference between the estimated value and the measured value. Here, the advertisement providing system may additionally perform operations S1461 and S1461 during operation S1460 as shown in FIG. 14, to determine the bid price.

In operation 1461, the advertisement providing system calculates a weight generated by an error between the estimated value and the measured value with respect to the unit time. Here, the advertisement providing system may calculate a ratio of the measured value with respect to the estimated value. For example, when the measured value is ‘80’ and the estimated value is ‘100’, the weight becomes ‘80/100=0.8.’

Alternatively, the advertisement providing system may calculate a cost corresponding to the difference between the estimated value and the measured value as the weight. For example, when the measured value is ‘80’ and the estimated value is ‘100’, the cost corresponding to the difference ‘80−100=−20’ may be calculated as the weight. The cost for ‘−20’ may be calculated in various standards or methods. For example, the cost may be calculated in the same manner as calculation of the minimum bid price.

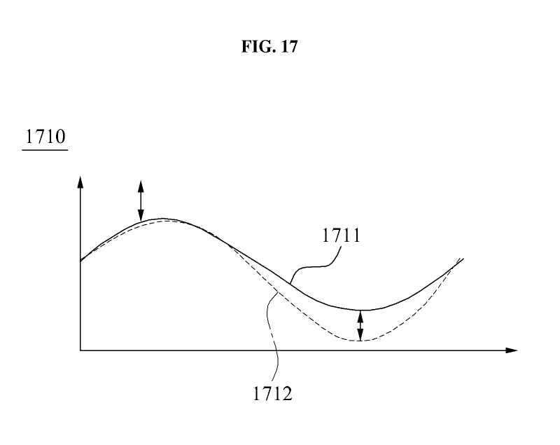

In operation 1462, the advertisement providing system may calculate the advertising fee with respect to the advertisement exposure for the unit time, by reflecting the weight to the bid price. The weight may be reflected to the bid price in various manners according to a weight calculation method. For example, when the weight is the ratio of the measured value with respect to the estimated value, the weight may be reflected based on a multiplication calculation. When the weight is the cost for the difference between the estimated value and the measured value, the weight may be reflected based on an addition calculation. In addition, the weight caused by the error may be reflected only when the measured value is smaller than the estimated value. The method of reflecting the weight only when the measured value is smaller than the estimated value will be described in further detail with reference to FIG. 17.

According to the advertisement providing method, the advertising fee may be determined based on the measured value of the actual advertising traffic, the estimated value of the estimated advertising traffic, and the bid price with respect to the unit time input by the advertiser. Also, the gap between the estimated advertising effect and the actual advertising effect caused by the difference between the estimated advertising traffic and the measured advertising traffic may be reduced. The advertising fee is calculated based on the use value per unit time of the advertisement region rather than being calculated according to clicks of the advertisement. Therefore, problems caused by malicious clicks by one particular user or group may be fundamentally prevented.

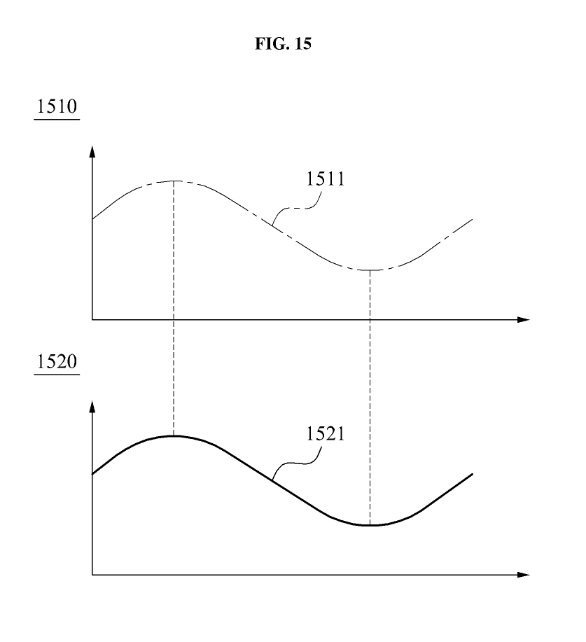

FIG. 15 illustrates a graph showing information on the estimated value of the advertising traffic and the bid price. In a graph 1510, an x-axis denotes time and a y-axis denotes an amount of the advertising traffic. A dashed dot line 1511 in the graph 1510 denotes the estimated values of the advertising traffic according to time. In a graph 1520, an x-axis denotes time and a y-axis denotes an amount of the bid price. A solid line 1521 in the graph 1520 denotes the bid prices input per unit time. That is, FIG. 15 shows an example of the bid price input in proportion to the estimated value of the advertising traffic according to time.

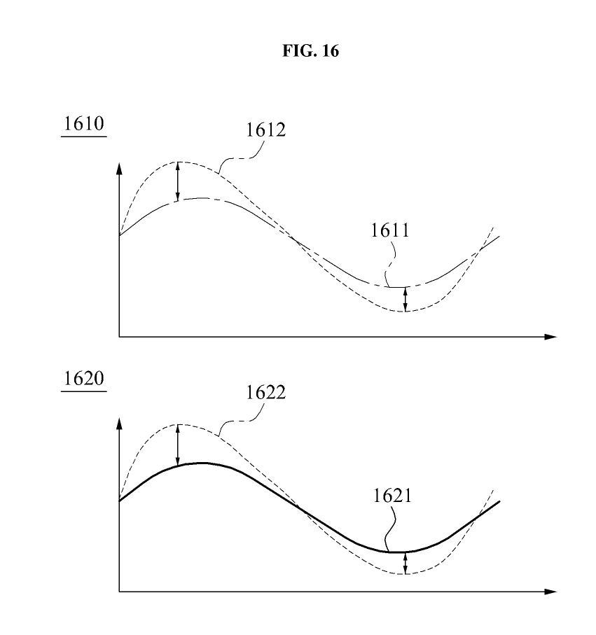

FIG. 16 illustrates a graph showing information on the estimated value of the advertising traffic, the measured value of the actual advertising traffic, the bid price, and the advertising fee. In a graph 1610, an x-axis denotes time and a y-axis denotes an amount of the advertising traffic. A dashed dot line 1611 in the graph 1610 denotes an example of the estimated value of the advertising traffic according to time. A first dotted line 1612 denotes an example of the actual advertising traffic according to time. In a graph 1620, an x-axis denotes time and a y-axis denotes an amount of the bid price. A solid line 1621 in the graph 1620 denotes the bid prices input per unit time. A second dotted line 1622 denotes the advertising fee according to time, which is determined by adjusting the bid price according to the difference between the estimated value and the measured value per unit time. That is, FIG. 16 shows an example operation of calculating the weight according to the gap between the estimated value and the measured value of the advertising traffic, and determining the advertising fee by reflecting the weight to the bid price.

As aforementioned, the weight caused by the error may be reflected only when the measured value is smaller than the estimated value. FIG. 17 illustrates a graph showing the information on the bid price and the advertising fee. In a graph 1710, an x-axis denotes time and a y-axis denotes an amount of the bid price. A solid line 1711 in the graph 1710 denotes the bid prices input per unit time. A dotted line 1712 denotes the advertising fee according to time, which is determined by adjusting the bid price according to the difference between the estimated value and the measured value per unit time. That is, according to FIG. 17, the charge is not additionally imposed when the estimated value is equal to or smaller than the measured value, and the advertising fee is discounted only when the estimated value is greater than the measured value. Thus, compensation for the advertiser may be provided when the actual advertising effect is smaller than the estimated advertising effect. In a case that the actual advertising traffic is greater than the estimated advertising traffic because the estimated value is smaller than the measured value of the advertising traffic, additional advertising traffic may be reflected to the estimated value of the advertising traffic in relation to a next bidding.

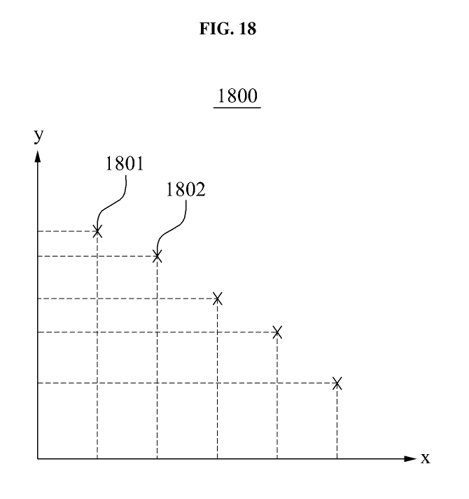

Next, calculation of the use value based on the number of clicks and the CPC of the advertisement history information will be briefly explained with reference to FIGS. 18 to 20.

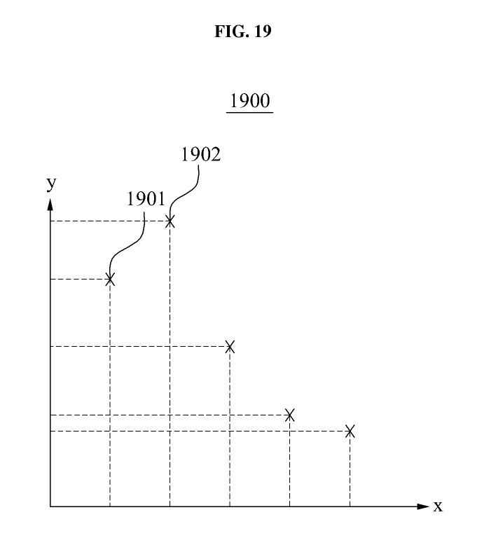

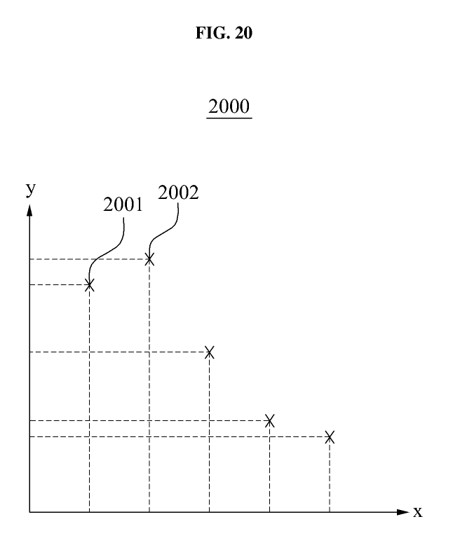

FIG. 18 illustrates a graph showing the CPC according to advertisement regions. FIG. 19 illustrates a graph showing the number of clicks according to advertisement regions. FIG. 20 illustrates a graph showing the use value according to advertisement regions. In a graph 1800 of FIG. 18, an x-axis denotes the advertisement region and a y-axis denotes the CPC. For example, a first coordinate 1801 indicates ‘100 won’ as the CPC of a ‘first advertisement region.’ A second coordinate 1802 indicates ‘90 won’ as the CPC of a ‘second advertisement region.’ In a graph 1900 of FIG. 19, an x-axis denotes the advertisement region and a y-axis denotes the number of clicks. The number of clicks of FIG. 17 may include an average number of clicks per unit time, which is calculated over the entire measurement period considering the time as the unit time. For example, a third coordinate 1901 shows ‘10 times’ as the average number of clicks occurring with 30 minutes as the unit time with respect to the ‘first advertisement region.’ A fourth coordinate 1902 shows ‘12 times’ as the average number of clicks occurring with 30 minutes as the unit time with respect to the ‘second advertisement region.’ Last, in a graph 2000 of FIG. 20, an x-axis denotes the advertisement region and a y-axis denotes the use value. For example, a fifth coordinate 2001 shows ‘1000 won’ as the use value with respect to the ‘first advertisement region’ calculated by multiplying the CPC ‘100 won’ by the number of clicks ‘10 times.’ A sixth coordinate 2002 shows ‘1080 won’ as the use value with respect to the ‘second advertisement region’ calculated by multiplying the CPC ‘90 won’ by the number of clicks ‘12 times.’ That is, the use value may indicate utility per advertisement region and may be used in selling the advertisement region.

When the use value of the advertisement region is determined as explained with reference to FIGS. 18 to 20, the advertisement providing system may determine the minimum bid price related to the advertisement region, based on the use value, and receives input of the bid price by the advertiser with reference to the minimum bid price.

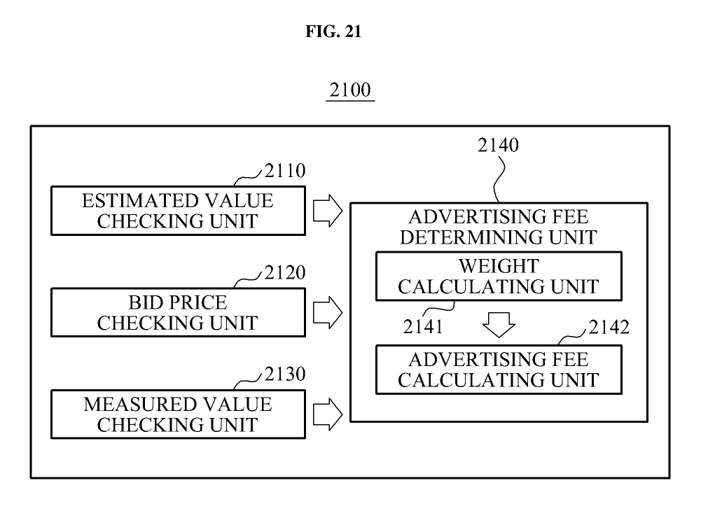

FIG. 21 illustrates a block diagram explaining an inner structure of an advertisement providing system according to an embodiment of the present invention. The advertisement providing system according to the present embodiment may include an estimated value checking unit 2110, a bid price checking unit 2120, a measured value checking unit 2130, and an advertising fee checking unit 2140.

The estimated value checking unit 2110 checks the estimated value of the advertising traffic with respect to the unit time. For example, when one day is divided into 144 unit times of a 10-minute interval, the estimated value of the advertising traffic may be determined with respect to at least one of the 144 unit times. The estimated value checking unit 2110 may check the estimated value of the advertising traffic with respect to the unit time. Here, the advertising traffic may be expressed using at least one of any information capable of quantifying quantity of the advertisement, such as a number of exposures of the advertisement for a predetermined time or a page view. When the number of exposures is used to quantify the advertising traffic, the estimated number of exposures during the unit time may be calculated as the estimated value of the advertising traffic. The advertisement providing system may check the estimated value by referring to the estimated number of exposures.

The bid price checking unit 2120 may check the bid price input by the advertiser with respect to the unit time. For example, the advertiser may input the bid price with respect to the unit time so as to expose the advertisement through the advertiser page 1320 of FIG. 13. The bid price checking unit 2120 may check the bid price being input. Here, since the estimated value of the advertising traffic is provided to the advertiser, the advertiser may determine the bid price to be input by referring to the estimated value. In addition, the bid price may be equal to or greater than the minimum bid price determined based on the use value per unit time of the advertisement region.

The advertisement providing system 2100 may determine the advertisement region to expose the advertisement of the advertiser based on the bid price. For example, the advertisement providing system 2100 may determine the advertisement region such that the advertisement region is sold to an advertiser suggesting a highest bid price among the input bid prices. The use value may be calculated using advertisement history information related to the advertisement region. The advertisement history information may include at least one of all types of measurable information related to the advertisement region, such as the number of clicks, the CPC, the number of hits, the number of exposures, and the number of purchases. That is, the use value may be an indicator representing the use information of the corresponding advertisement region at a corresponding time. For example, the minimum cost for use of the advertisement region during the corresponding time may be used as the use value. In addition, the advertisement providing system 2100 may expose the advertisement of the advertiser through the determined advertisement region. For example, the advertisement may be exposed to the users through a corresponding advertisement region on the user terminals, the advertisement region among the advertisement regions exposed through at least one of the various web pages 1330 of FIG. 13.

The measured value checking unit 2130 may check the measured value of the actual advertising traffic with respect to the unit time. For example, when the number of exposures of the advertisement is used to quantify the advertising traffic, the number of exposures of the advertisement of the advertiser during the unit time may be measured as the measured value. In this case, the measured value checking unit 2130 may refer to the number of exposures to check the measured value.

The advertising fee determining unit 2140 may determine the advertising fee based on the estimated value, the measured value, and the bid price. For example, the advertising fee determining unit 2140 may determine the advertising fee such that the gap between the estimated advertising effect and the actual advertising effect caused by the difference between the estimated value and the measured value is adjusted. Here, the advertising fee determining unit 2140 may include a weight calculating unit 2141 and an advertising fee calculating unit 2142 as shown in FIG. 21.

The weight calculating unit 2141 may calculate the weight generated by the error between the estimated value and the measured value with respect to the unit time. Here, the weight calculating value 2141 may calculate the ratio of the measured value with respect to the estimated value, as the weight. For example, when the measured value is ‘80’ and the estimated value is ‘100’, the weight becomes ‘80/100=0.8.’

Alternatively, the weight calculating unit 2141 may calculate the cost for the difference between the estimated value and the measured value as the weight. For example, when the measured value is ‘80’ and the estimated value is ‘100’, the cost corresponding to the difference ‘80−100=−20’ may be calculated as the weight. The cost for ‘−20’ may be calculated in various standards or methods. For example, the cost may be calculated in the same manner as calculation of the minimum bid price.

The advertising fee calculating unit 2141 may calculate the advertising fee with respect to the advertisement exposure for the unit time, by reflecting the weight to the bid price. The weight may be reflected to the bid price in various manners according to a weight calculation method. For example, when the weight is the ratio of the measured value with respect to the estimated value, the weight may be reflected based on a multiplication calculation. When the weight is the cost for the difference between the estimated value and the measured value, the weight may be reflected based on an addition calculation. In addition, the weight caused by the error may be reflected only when the measured value is smaller than the estimated value.

As described above, according to the advertisement providing system, the advertising fee may be determined based on the measured value of the actual advertising traffic, the estimated value of the estimated advertising traffic, and the bid price with respect to the unit time input by the user. Also, the gap between the estimated advertising effect and the actual advertising effect, which is caused due to the difference between the estimated advertising traffic and the actual advertising traffic, may be reduced. In addition, the advertising fee is calculated based on the use value per unit time of the advertisement region rather than being calculated according to clicks of the advertisement. Therefore, problems caused by malicious clicks by one particular user or group may be fundamentally prevented.

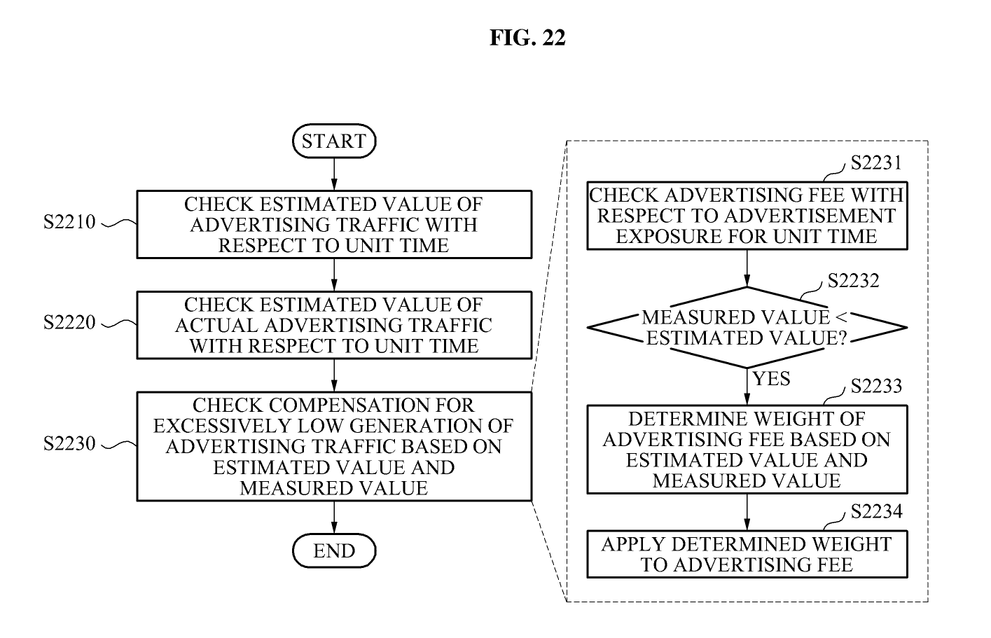

FIG. 22 illustrates a flowchart explaining an advertisement providing method according to another embodiment of the present invention. In FIG. 22, the advertisement providing method may be performed by the advertisement providing system according to the embodiment of the present invention. FIG. 22 explains the advertisement providing method by illustrating respective processes performed by the advertisement providing system.

In operation S2210, the advertisement providing system checks the estimated value of the advertising traffic with respect to the unit time. For example, when one day is divided into 144 unit times of a 10-minute interval, the estimated value of the advertising traffic may be determined with respect to at least one of the 144 unit times. Therefore, the advertisement providing system may check the estimated value of the advertising traffic with respect to the unit time. Here, the advertising traffic may be expressed using at least one of any information capable of quantifying quantity of the advertisement, such as a number of exposures of the advertisement for a predetermined time or a page view. When the number of exposures is used to quantify the advertising traffic, the estimated number of exposures during the unit time may be calculated as the estimated value of the advertising traffic. The advertisement providing system may check the estimated value by referring to the estimated number of exposures.

In operation S2220, the advertisement providing system checks the measured value of the actual advertising traffic with respect to the unit time. For example, when the number of exposures is used to quantify the advertising traffic, the number of exposures of the advertisement of the advertiser during the unit time may be measured as the measured value. In this case, the advertisement providing system may refer to the number of exposures to check the measured value.

In operation S2230, the advertisement providing system checks compensation caused when the advertising traffic is excessively small, based on the estimated value and the measured value. The compensation may be at least one of any type of compensation, such as monetary compensation or material compensation, provided to the advertiser for deficient advertising effect caused by the excessively small advertising traffic. That is, compensation is checked by the advertisement providing system in operation S2230 and then provided to the advertiser.

When the compensation for the excessively small advertising traffic is performed through discount of the advertising fee, operations S2231 to S2234 shown in FIG. 22 may be included in operation S2230.

In operation S2231, the advertisement providing system checks the advertising fee for the advertisement exposure for the unit time. Here, the advertising fee may be determined based on the bid price input by the advertiser. For example, assuming that one day is divided into 144 unit times of a 10-minute interval, when the advertiser inputs ‘1000 won’ as the bid price for the unit time from 12:30 to 12:40 out of the 144 unit times, the advertising fee for the unit time may be determined to be ‘1000 won.’

In operation S2232, the advertisement providing system compares the measured value with the estimated value and performs operation S2233 when the measured value is smaller than the estimated value. When the measured value is not smaller than the estimated value, the advertisement providing system may end checking of the compensation with respect to the unit time being currently processed. That is, the advertisement providing unit may perform operation S2210 again with respect to the unit time, or end the process when the currently processed unit time is a last unit time.

In operation S2233, the advertisement providing system determines the weight regarding the advertising fee based on the measured value and the estimated value. Here, the advertisement providing system may calculate the ratio of the measured value with respect to the estimated value as the weight. For example, when the measured value is ‘80’ and the estimated value is ‘100’, the weight becomes ‘80/100=0.8.’ Alternatively, the advertisement providing system may calculate the cost for the difference between the estimated value and the measured value with respect to the unit time, as the weight. For example, when the measured value is ‘80’ and the estimated value is ‘100’, the cost corresponding to the difference ‘80−100=−20’ may be calculated as the weight. The cost for ‘−20’ may be calculated in various standards or methods.

In operation S2234, the advertisement providing system applies the weight to the advertising fee. The weight may be applied in various manners according to the weight calculation method. For example, when the weight is the ratio of the measured value with respect to the estimated value, the weight may be reflected based on a multiplication calculation. When the weight is the cost for the difference between the estimated value and the measured value, the weight may be reflected based on an addition calculation.

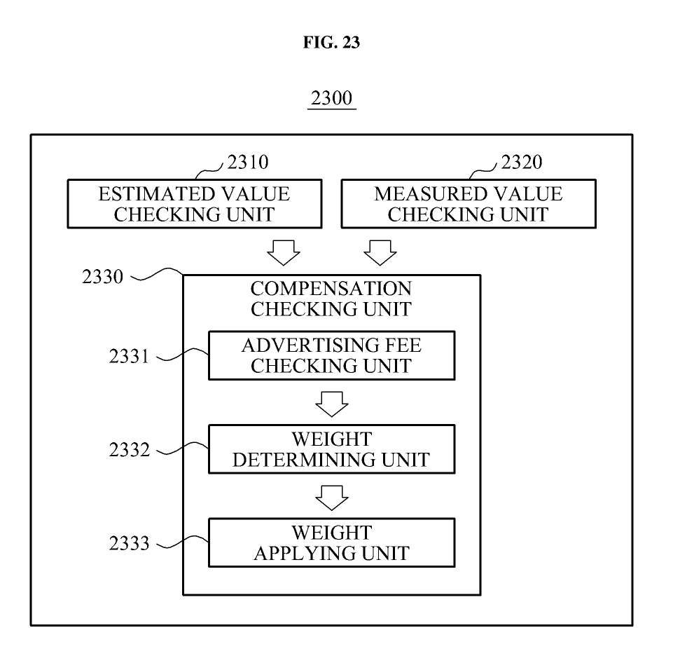

FIG. 23 illustrates a block diagram explaining an inner structure of an advertisement providing system 2300 according to another embodiment of the present invention. Referring to FIG. 23, the advertisement providing system 2300 may include an estimated value checking unit 2310, a measured value checking unit 2320, and a compensation checking unit 2330.

The estimated value checking unit may check the estimated value of the advertising traffic with respect to the unit time. For example, when one day is divided into 144 unit times of a 10-minute interval, the estimated value of the advertising traffic may be determined with respect to at least one of the 144 unit times. The estimated value checking unit 2310 may check the estimated value of the advertising traffic with respect to the unit time. Here, the advertising traffic may be expressed using at least one of any information capable of quantifying quantity of the advertisement, such as a number of exposures of the advertisement for a predetermined time or a page view. When the number of exposures is used to quantify the advertising traffic, the estimated number of exposures during the unit time may be calculated as the estimated value. The estimated value checking unit 2310 may check the estimated value by referring to the estimated number of exposures.

The measured value checking unit 2320 may check the measured value of the actual advertising traffic with respect to the unit time. For example, when the number of exposures is used to quantify the advertising traffic, the number of exposures of the advertisement of the advertiser during the unit time may be measured as the measured value. In this case, the measured value checking unit 2320 may refer to the number of exposures to check the measured value.

The compensation checking unit 2330 checks the compensation for the excessively small advertising traffic based on the estimated value and the measured value. The compensation may be at least one of any type of compensation, such as monetary compensation or material compensation, provided to the advertiser for deficient advertising effect caused by the excessively small advertising traffic. That is, compensation is checked by the compensation checking unit 2330 and then provided to the advertiser.

When the compensation for the excessively small advertising traffic is performed through discount of the advertising fee, the advertising fee checking unit 2331, the weight determining unit 2332, and the weight applying unit 2333 may be included in the compensation checking unit 2330.

The advertising fee checking unit 2331 checks the advertising fee for the advertisement exposure for the unit time. Here, the advertising fee may be determined based on the bid price input by the advertiser. For example, assuming that one day is divided into 144 unit times of a 10-minute interval, when the advertiser inputs ‘1000 won’ as the bid price for the unit time from 12:30 to 12:40 out of the 144 unit times, the advertising fee for the unit time may be determined to be ‘1000 won.’

The weight determining unit 2332 may determine the weight with respect to the advertising fee based on the measured value and the estimated value. Here, the weight determining unit 2332 may calculate the ratio of the measured vale with respect to the estimated value as the weight. For example, when the measured value is ‘80’ and the estimated value is ‘100’, the weight becomes ‘80/100=0.8.’ Alternatively, the weight determining unit 2332 may calculate the cost for the difference between the estimated value and the measured value with respect to the unit time, as the weight. For example, when the measured value is ‘80’ and the estimated value is ‘100’, the cost corresponding to the difference ‘80−100=−20’ may be calculated as the weight. The cost for ‘−20’ may be calculated in various standards or methods.

The weight applying unit 2333 may apply the above-determined weight to the advertising fee. The weight may be applied in various manners according to the weight calculation method. For example, when the weight is the ratio of the measured value with respect to the estimated value, the weight applying unit 2333 may apply the weight based on a multiplication calculation. When the weight is the cost for the difference between the estimated value and the measured value, the weight applying unit 2333 may apply the weight based on an addition calculation.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for holding an auction in relation to a search advertisement on a network, the method comprising:
receiving bid information related to the search advertisement from an advertiser calculating device, the bid information comprising a search keyword, a posted time of the search advertisement, and a bid price for the search advertisement;
determining a posting position, a posting order, or both the posting position and the posting order of the search advertisement with respect to a predetermined time slot of the posted time of the search advertisement based on the bid price corresponding to the time slot; and
posting the search advertisement according to the determined posting position, the posting order, or both the posting position and the posting order for the predetermined time slot.

2. The method of claim 1, wherein the bid price is determined by the advertiser calculating device based on a starting bid price supplied in advance.

3. The method of claim 2, wherein the bid price is determined based on history data with respect to the search keyword.

4. The method of claim 3, wherein the history data with respect to the search keyword comprises at least one of a number of postings of the search advertisement during a predetermined past time, a number of clicks of advertisement information of the corresponding search advertisement, or a charge for the corresponding search advertisement.

5. The method of claim 2, wherein the starting bid price is determined as an average of amounts charged for the search advertisement with respect to the search keyword and is posted during the predetermined past time.

6. The method of claim 2, wherein the starting bid price is determined as an amount charged for the search advertisement with respect to the search keyword, posted during a previous time of the predetermined past time.

7. The method of claim 1, wherein the determining of the posting position, the posting order, or both the posting position and the posting order of the search advertisement is performed such that a search advertisement having a higher bid price has a higher posting position, posting order, or both the higher posting position and the posting order.

8. A method for imposing a charge in relation to a search advertisement on a network, the method comprising:
receiving bid information related to the search advertisement from an advertiser calculating device, the bid information comprising a search keyword, a posted time of the search advertisement, and a bid price for the search advertisement;
determining a charge when posting of the search advertisement is completed based on a posted time of the search advertisement and the bid price; and
imposing the charge.

9. The method of claim 8, wherein the charge is determined as a sum total of products of respective time slots, during which the search advertisement is posted, and bid prices respectively corresponding to the time slots.

10. A system for holding an auction in relation to a search advertisement on a network, the system comprising:
an auction managing unit to receive bid information related to the search advertisement from an advertiser calculating device, the bid information comprising a search keyword, a posted time of the search advertisement, and a bid price for the search advertisement; and
an advertisement executing unit to determine a posting position, a posting order, or both the posting position and the posting order of the search advertisement with respect to a predetermined time slot of the posted time of the search advertisement based on the bid price corresponding to the time slot.

11. The system of claim 10, wherein the bid price is determined by the advertiser calculating device based on a starting bid price supplied in advance.

12. The system of claim 11, wherein the starting bid price is determined based on history data with respect to the search keyword.

13. The system of claim 12, wherein the history data with respect to the search keyword comprises at least one of a number of postings of the search advertisement during a predetermined past time, a number of clicks of advertisement information of the corresponding search advertisement, or a charge for the corresponding search advertisement.

14. The system of claim 11, wherein the starting bid price is determined as an average of amounts charged for the search advertisement with respect to the search keyword and is posted during the predetermined past time.

15. The system of claim 11, wherein the starting bid price is determined as an amount charged for the search advertisement with respect to the search keyword and is posted during a previous time of the predetermined past time.

16. The system of claim 10, wherein the advertisement executing unit determines the posting position, the posting order, or both the posting position and the positing order such that a search advertisement having a higher bid price has a higher posting position, posting order, or both the higher position and the posting order.

17. A system for imposing a charge for a search advertisement on a network, the system comprising:
an auction managing unit to receive bid information related to the search advertisement from an advertiser calculating device, the bid information comprising a search keyword, a posted time of the search advertisement, and a bid price for the search advertisement; and
a charge managing unit to determine a charge based on a posted time of the search advertisement and the bid price when posting of the search advertisement is completed and to impose the charge.

18. The system of claim 17, wherein the charge is determined as a sum total of products of respective time slots, during which the search advertisement is posted, and bid prices respectively corresponding to the time slots.

19. A method for restricting bidding in relation to a search advertisement on a network, the method comprising:
receiving bid information related to the search advertisement from an advertiser calculating device, the bid information comprising a search keyword, a posted time of the search advertisement, and a bid price for the search advertisement; and
determining whether to restrict bidding of the search advertisement based on the bid information,
wherein the search advertisement is posted in a descending order of the bid price during the posted time of the search advertisements when the bidding is not restricted.

20. The system of claim 19, wherein the determining whether to restrict the bidding is performed by determining whether the search keyword is registered as a predetermined forbidden keyword.

21. The method of claim 20, wherein the forbidden keyword comprises a search keyword which is offensive in view of public morals, a search keyword having an obscene meaning, and a search keyword related to goods socially unacceptable for distribution.

22. The method of claim 19, wherein
the bid information further comprises information on a website of the advertiser, and
the determining whether to restrict the bidding is performed by determining whether the website of the advertiser is registered as a predetermined forbidden site.

23. The method of claim 22, wherein the forbidden site comprises an adult site or an illegal site.

24. The method of claim 19, wherein the determining whether to restrict the bidding is performed by determining whether the bid price exceeds a balance of deposit in an account of the advertiser.

25. The method of claim 19, wherein the determining whether to restrict the bidding is performed by determining whether the bid price exceeds a maximum allowable bid price related to the search keyword.

26. The method of claim 19, further comprising:
transmitting an alert message notifying the advertiser calculating device of restriction of the bidding when the bidding is determined to be restricted during the determination.

27. The method of claim 26, wherein the alert message comprises a guidance message notifying of lack of a balance of deposit in an account of the advertiser and instructing to recharge the deposit.

28. A non-transitory computer readable recording medium storing a program to cause a computer to implement the method of claim 1.

29. A system for restricting bidding in relation to a search advertisement on a network, the system comprising:
a communication unit to receive bid information related to the search advertisement from an advertiser calculating device, the bid information comprising a search keyword, a posted time of the search advertisement, and a bid price for the search advertisement; and
a bidding restricting unit to determine whether to restrict the bidding in relation to the search advertisement based on the bid information,
wherein the search advertisement is posted in a descending order of the bid price during the posted time of the search advertisements when the bidding is not restricted.

30. The system of claim 29, wherein the bidding restricting unit is configured to determine whether the search keyword is registered as a predetermined forbidden keyword.

31. The system of claim 30, wherein the forbidden keyword comprises a search keyword which is offensive in view of public morals, a search keyword having an obscene meaning, and a search keyword related to goods socially unacceptable for distribution.

32. The system of claim 29, wherein
the bid information further comprises information on a website of the advertiser, and
the bidding restricting unit is configured to determine whether the website of the advertiser is registered as a predetermined forbidden site.

33. The system of claim 32, wherein the forbidden site comprises an adult site or an illegal site.

34. The system of claim 29, wherein the bidding restricting unit determines whether the bid price exceeds a balance of deposit in an account of the advertiser.

35. The system of claim 29, wherein the bidding restricting unit is configured to determine whether the bid price exceeds a maximum allowable bid price related to the search keyword.

36. The system of claim 29, wherein the bidding restricting unit is configured to transmit an alert message notifying the advertiser calculating device of restriction of the bidding when the bidding is determined to be restricted during the determining.

37. The system of claim 36, wherein the alert message comprises a guidance message notifying of lack of a balance of deposit in an account of the advertiser and instructing to recharge a deposit.
